(19) United States
(12) Patent Application Publication
(10) Pub. No.: US 2006/0231723 A1
(43) Pub. Date: Oct. 19, 2006

(54) Universal clamp for fishing rod holders

(76) Inventor: Mark Fayerman, West Hollywood, CA (US)

Correspondence Address: Mark Fayerman, 1005 North Stanley Avenue, # 201, West Hollywood, CA, 90046, US

(21) Appl. No.: 11/091,087

(22) Filed: Mar. 28, 2005

(51) Int. Cl. A01K 97/10; A47B 96/06

(52) U.S. Cl. 248/540; 248/229.15; 248/228.1

(57) ABSTRACT

A universal clamp is provided for mounting fishing rod holders on rigid surfaces. The universal clamp comprises a main body having three sidewalls. One sidewall has an aperture over which a grooved nut is attached to the sidewall. A bolt is inserted into the nut, the bolt including a metallic disk on one end. A pipe is attached to at least one other sidewall of the main body. The pipe includes a generally centered aperture over which a nut is secured to the pipe, and a hollow cavity for accommodating a stake of a fishing rod holder. A bolt goes through the nut and aperture in the pipe to secure the fishing rod holder stake to the universal clamp. The universal clamp of the present invention allows the use of a fishing rod holder not only on the shores of water basins, but also from boats, bridges, and piers.

### FIELD OF THE INVENTION

The present invention relates to universal clamps for fishing rod holders, and more particularly, to universal clamps for mounting fishing rod holders on various rigid surfaces which can be used as fishing locations.

### BACKGROUND OF THE INVENTION

There are many commercially available fishing rod holders. They principally consist of a metal stake that is inserted into the ground and a pipe or pipe-like member attached to the metal stake that accommodates a fishing rod. In order to be properly set up, the metal stake of a typical fishing rod holder has to penetrate the ground to a depth of at least four or five inches. Thus, a typical existing fishing rod holder requires a fisherman to use such a holder only in locations where the ground is soft enough so that it can be penetrated by the metal stake.

Currently, the locations that allow the use of conventional fishing rod holders include sandy shores, soft gravel, or other such surfaces that can be penetrated deep enough by the metal stake. It is typically not possible to fish using the existing fishing rod holders on surfaces such as asphalt, wooden surfaces (as on piers and bridges), and on metallic surfaces (as on fishing boats). Thus, there is a present need for a device that would allow the mounting of a fishing rod holder not only on the soft surfaces of beaches and shores, but also on the rigid surfaces of piers, bridges and boats.

### BRIEF DESCRIPTION OF THE INVENTION

The invention satisfies this need. According to the invention, there is provided a universal clamp for mounting fishing rod holders on rigid surfaces. The universal clamp is compact and easy to use, allowing a fisherman to fish while using a fishing rod holder in locations such as piers, bridges and fishing boats.

The universal clamp of the invention comprises a main body having three sidewalls. One of the sidewalls has an aperture directly over which a grooved nut is fixedly attached to the sidewall. A bolt is inserted into the nut, the bolt including a metallic disk on one end. At least one pipe is attached to at least one other sidewall of the main body. The pipe includes a generally centered aperture and a hollow cavity for accommodating a stake of a fishing rod holder. A nut having internal grooves is fixedly attached to the pipe directly over the aperture in the pipe. A bolt having grooves to match the grooves on this nut is screwed into the nut to secure the fishing rod holder to the universal clamp. The universal clamp can be securely attached to various rigid surfaces, thus allowing a fisherman to mount a fishing rod holder in a great variety of fishing locations.

In the preferred embodiment of the invention, the universal clamp comprises two pipes, each being attached to its own sidewall of the main body. In another embodiment, the bolts used with the universal clamp can contain winged-nuts for ease of screwing and unscrewing the bolts. In another embodiment, the metallic disk attached to one of the bolts can be curved to allow better engagement of the universal clamp with the mounting surface.

The universal clamp has been made and tested by me for use with my earlier patented invention of fishing rod holder with automatic trigger (U.S. Pat. No. 6,681,516). However, this universal clamp can be made in any size and may be adapted to work with any other fishing rod holder currently available on the market as well. The universal clamp of the present invention allows the use of a fishing rod holder not only on the shores of water basins, but also from boats, bridges, and piers.

### BRIEF DESCRIPTION OF THE DRAWINGS

The present invention is illustrated by way of example, and not limitation, by the figures of the accompanying drawings in which like references indicate similar elements and in which:

FIG. 1 is a general perspective view of the universal clamp of the invention shown in a top-mounting orientation.

FIG. 1a is a side view of the preferred embodiment shown in a left-mounting orientation.

FIG. 1b is another side view of the preferred embodiment shown in a right-mounting orientation.

FIG. 2 is a detailed view of all of the individual parts making up the universal clamp of the invention.

FIG. 3 schematically illustrates the manufacturing process of the preferred embodiment of the invention.

FIG. 4 is a perspective view of the preferred embodiment of the invention in a top-mounting orientation on a wooden handrail of a pier while holding a fishing rod holder with automatic trigger.

FIG. 5 is a perspective view of the universal clamp of the invention as mounted on the side part of a boat bench while holding the fishing rod holder with automatic trigger.

### DETAILED DESCRIPTION OF THE PREFERRED EMBODIMENTS

In the following description of the preferred embodiments reference is made to the accompanying drawings, which are shown by way of illustration of specific embodiments in which the invention may be practiced. It is to be understood that other embodiments may be utilized and structural and functional changes may be made without departing from the scope of the present invention.

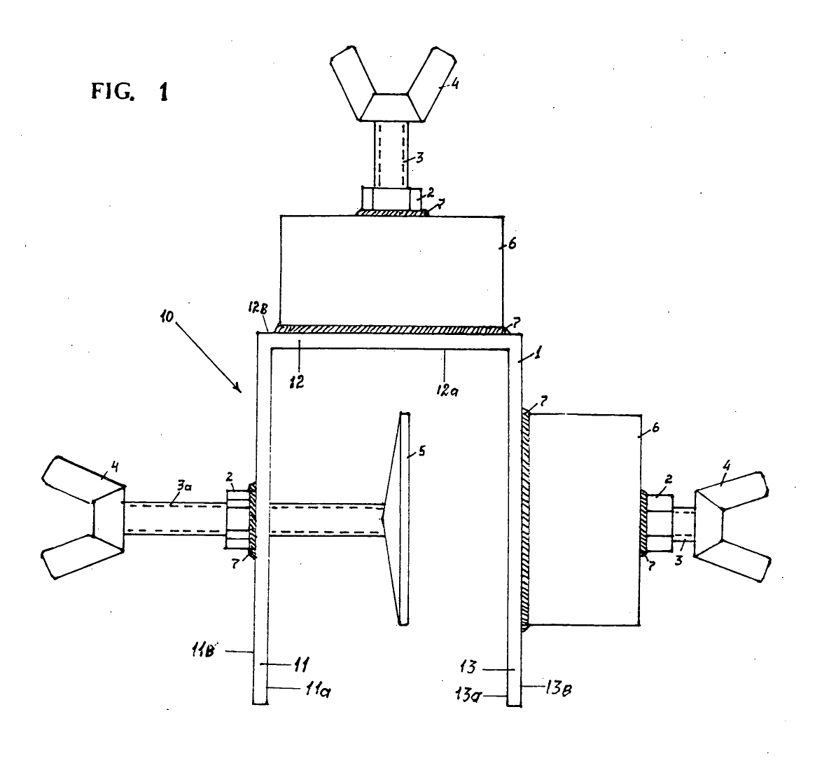

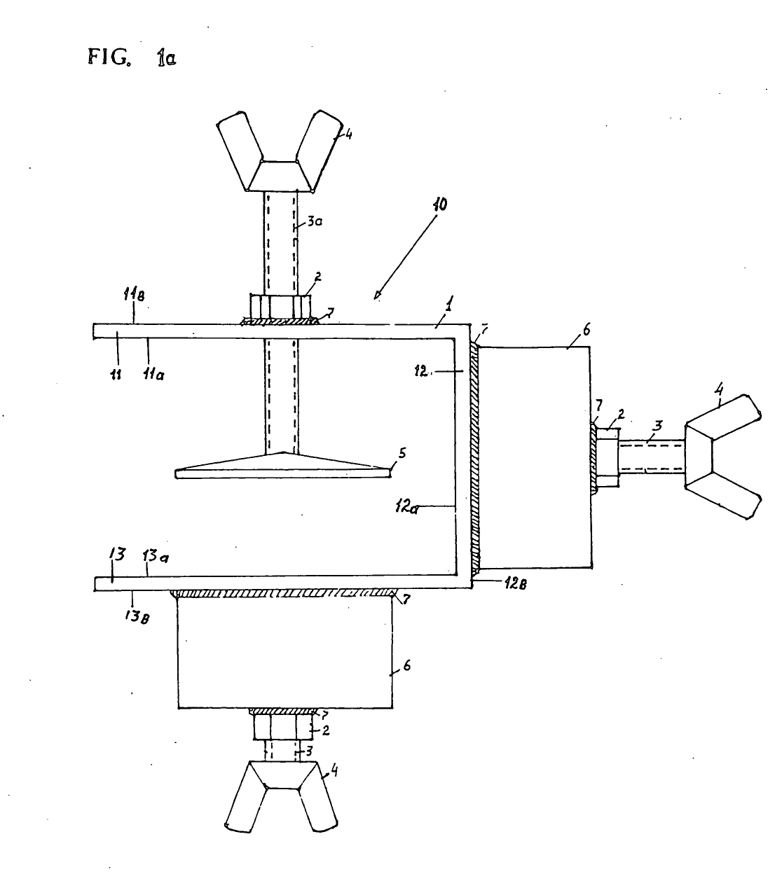

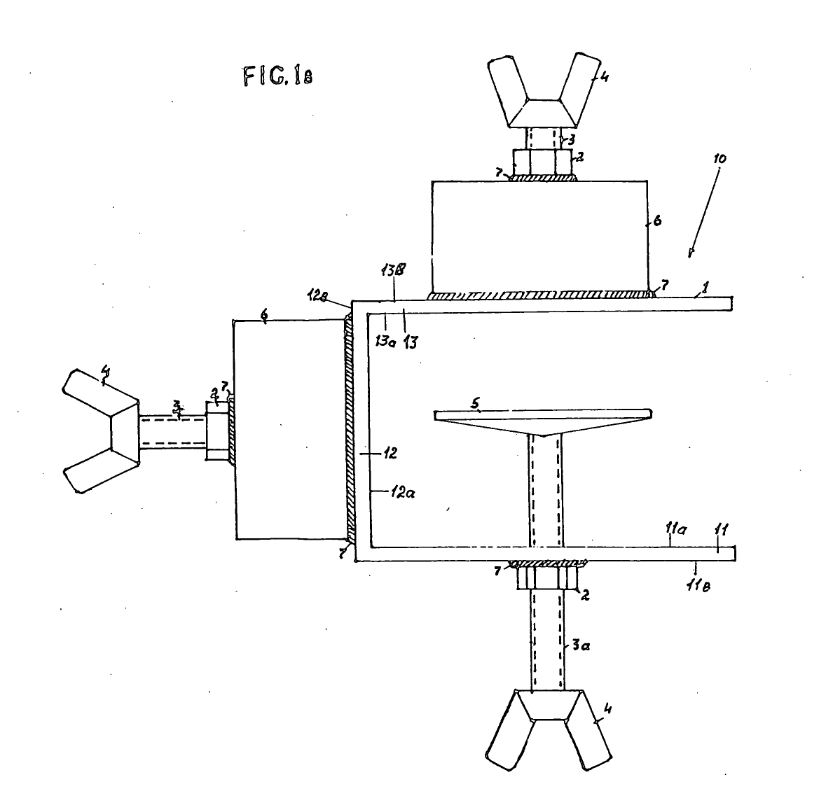

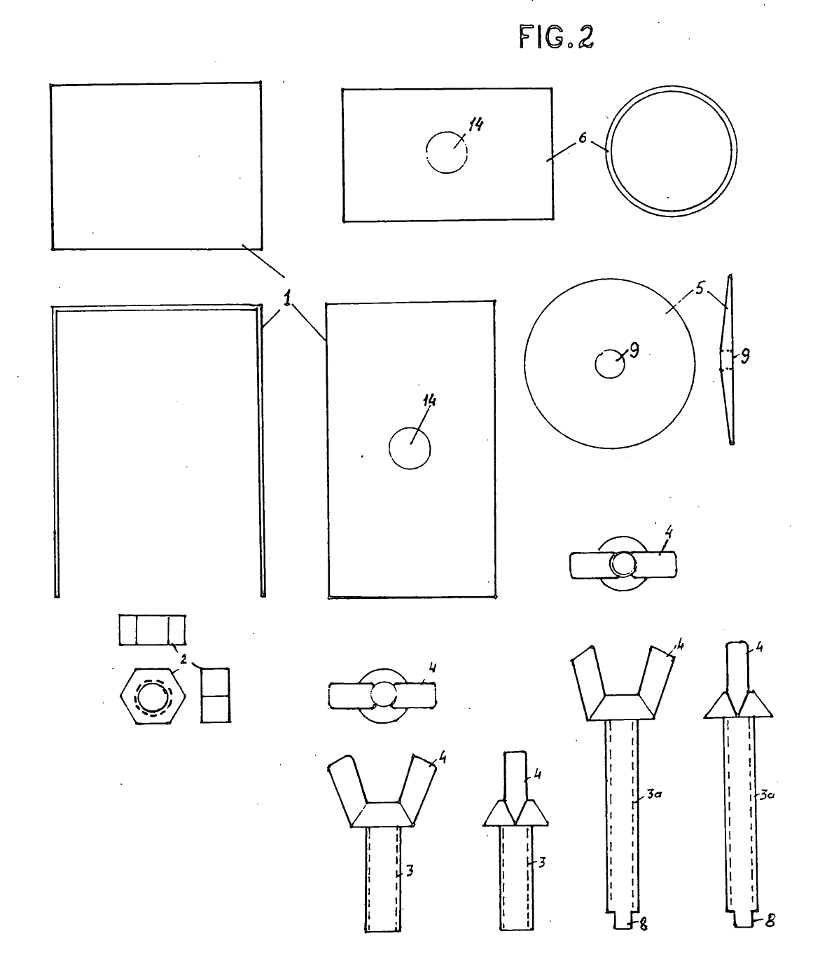

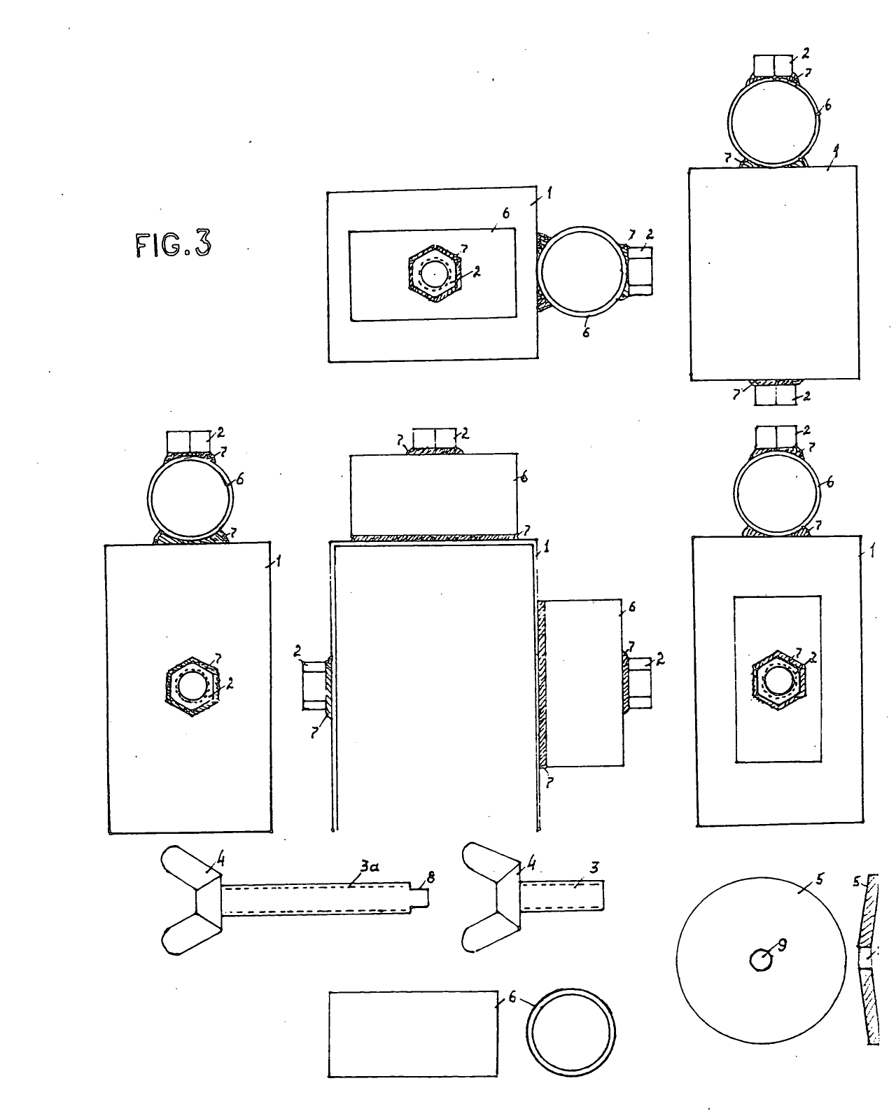

The invention is a universal clamp for attaching fishing rod holders to hard surfaces such as present on piers, bridges, or boats. FIGS. 1, 1a, and 1b, illustrate the preferred embodiment of the universal clamp of the invention in its assembled state and in various positions. FIGS. 2 and 3 illustrate the universal clamp of the invention in its unassembled state to show its individual parts in more detail.

Referring to FIGS. 1 and 1a, the universal clamp 10 comprises a main body 1. In the preferred embodiment of the invention, the main body 1 is typically made of a 2″ wide, 3/16″ thick, and 9.5″ long steel plate. The steel plate is generally rectangular in shape, and more specifically, is U-shaped. The main body 1 has three sidewalls, 11, 12, and 13. In the preferred embodiment, the sidewall 12 is 2.5″ long. The length of the two other sidewalls 11 and 13 is the same and is equal to 3.5″.

Referring to FIG. 2, sidewall 11 has an inside surface 11a, an outside surface 11b, and a generally centered aperture 14. In the preferred embodiment, the aperture 14 in sidewall 11 has a diameter of ⅜″. Sidewall 13 has an inside surface 13a and an outside surface 13b. Also, sidewall 12 has an inside surface 12a and an outside surface 12b.

Referring further to FIG. 1a, a nut 2 is welded to the inside surface 11a of the main body sidewall 11. Typically electric welding 7 is used. Preferably, the nut 2 is internally grooved and has a diameter of 5/16″. In the preferred embodiment of the invention, three such nuts 2 are used.

Referring to FIGS. 1 and 2, the universal clamp 10 further comprises a bolt 3a. The bolt 3a is typically 2.5″ long, and has a diameter of 5/16″. The top end of the bolt 3a also includes a winged nut 4 for ease of screwing and unscrewing the bolt 3 into and out of the nut 2. Referring to FIG. 2, the bottom end of the bolt 3a has a narrowed portion 8. The narrowed portion 8 has a diameter of 7/32″ and is 5/16″ in length.

Still referring to FIGS. 1 and 2, the universal clamp 10 further comprises a clamping disk 5. The clamping disk is typically circular in shape, and is made of steel. In the preferred embodiment, the clamping disk 5 has a diameter of 1.5″ and is ⅛″ thick. The clamping disk 5 has a circular aperture 9 approximately in its center. In the preferred embodiment, the aperture 9 has a diameter of ¼″.

Referring to FIG. 1a, the clamping disk 5 is secured to the bolt 3a at its narrowed portion 8. In the preferred embodiment, the clamping disk 5 is bent with a curvature of 3/16″. The purpose of the curvature of the clamping disk 5 is to allow the universal clamp 10 to be more securely engaged to the surface on which it is mounted (e.g., a handrail of a pier, bridge, or a bench on a boat).

Referring to FIGS. 1a and 2, the universal clamp 10 further comprises at least one pipe 6. The pipe 6 is preferably made out of steel, has a length of 2″, a wall thickness of ⅛″, and an internal diameter of 1⅛″. In the preferred embodiment of the invention, the universal clamp 10 comprises two such pipes 6. The pipe contains a hollow cavity, which is used to accommodate the metal stake of fishing rod holders.

FIG. 3 illustrates in more detail how the nut 2 is connected to the main body 1 of the universal clamp 10. The nut 2 is welded by electric welding 7 to the outside surface 11b of the main body sidewall 11. More specifically, the nut 2 is welded directly on top of the aperture 14 in the sidewall 11, allowing the bolt 3a to pass through the nut 2 and through the aperture 14.

Referring to FIGS. 1, and 2, the universal clamp 10 further comprises at least one bolt 3. Typically, the bolt 3 is 1.5″ long, and has a diameter of 5/16″. The top end of the bolt 3 includes a winged nut 4 for ease of screwing and unscrewing the bolt into and out of the nut 2. In the preferred embodiment, two such bolts 3 are used.

Referring further to FIGS. 1 and 3, one pipe 6 is welded by electric welding 7 to the sidewall 12 of the main body 1, and specifically, to the outside surface 12b. Another pipe 6 is welded by electric welding 7 to sidewall 13 of the main body 1, and specifically, to the outside surface 13b. Each pipe 6 has an aperture drilled through it. The aperture is drilled generally through the center of each pipe 6. A nut 2 is welded by electric welding 7 to the pipe 6 directly on top of the aperture in the pipe 6, allowing a bolt 3 to pass through the nut 2 and through the aperture in the pipe 6.

To fully assemble the universal clamp 10 of the invention to make it ready for use, two bolts 3 are inserted into the nuts 2 on the pipes 6, and the bolt 3a is inserted into the nut 2 on the outside surface 11b of the sidewall 11. After the bolt 3a goes through the aperture 14 in the sidewall 11, the clamping disk 5 is engaged with the narrowed portion 8. Once, the narrowed portion 8 of the bolt 3a passes through the aperture 5a in the center of the clamping disk 5, the narrowed portion 8 is riveted to fully secure the clamping disk 5 on the bolt 3a. Once the narrowed portion 8 is riveted, the clamping disk 5 can freely rotate on the narrowed portion 3b, but cannot fall off of it. Once assembled, the universal clamp 10 of the invention is typically coated with corrosion-resistant coating.

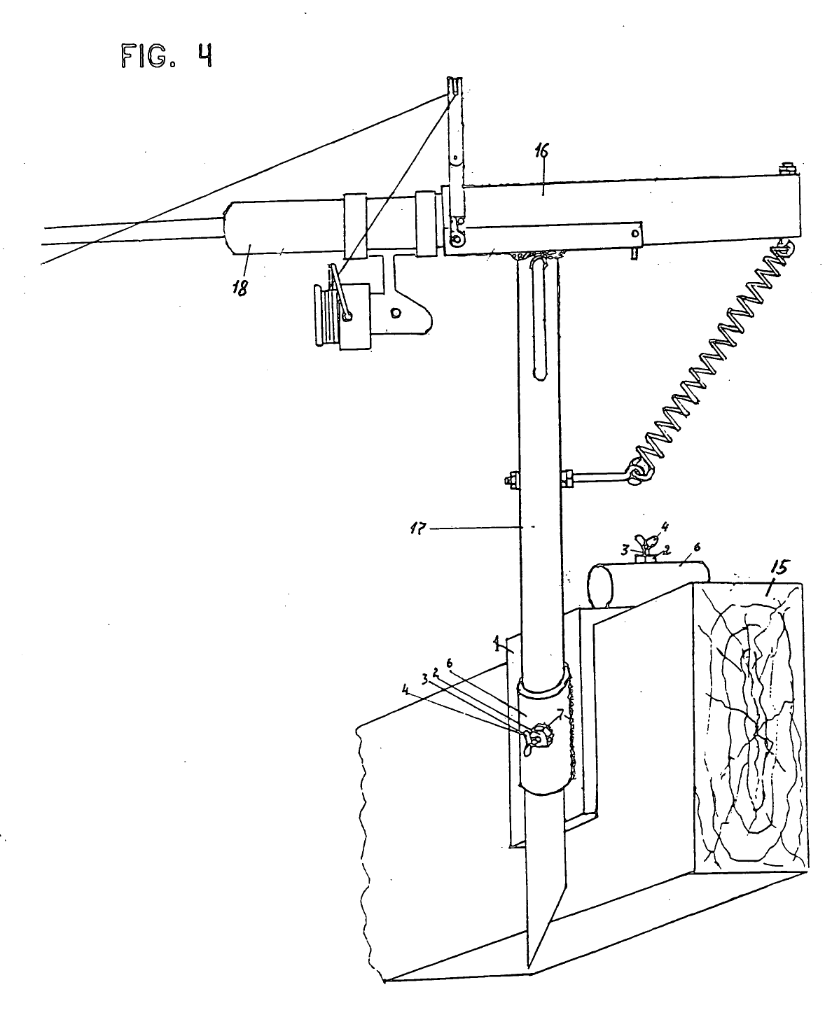

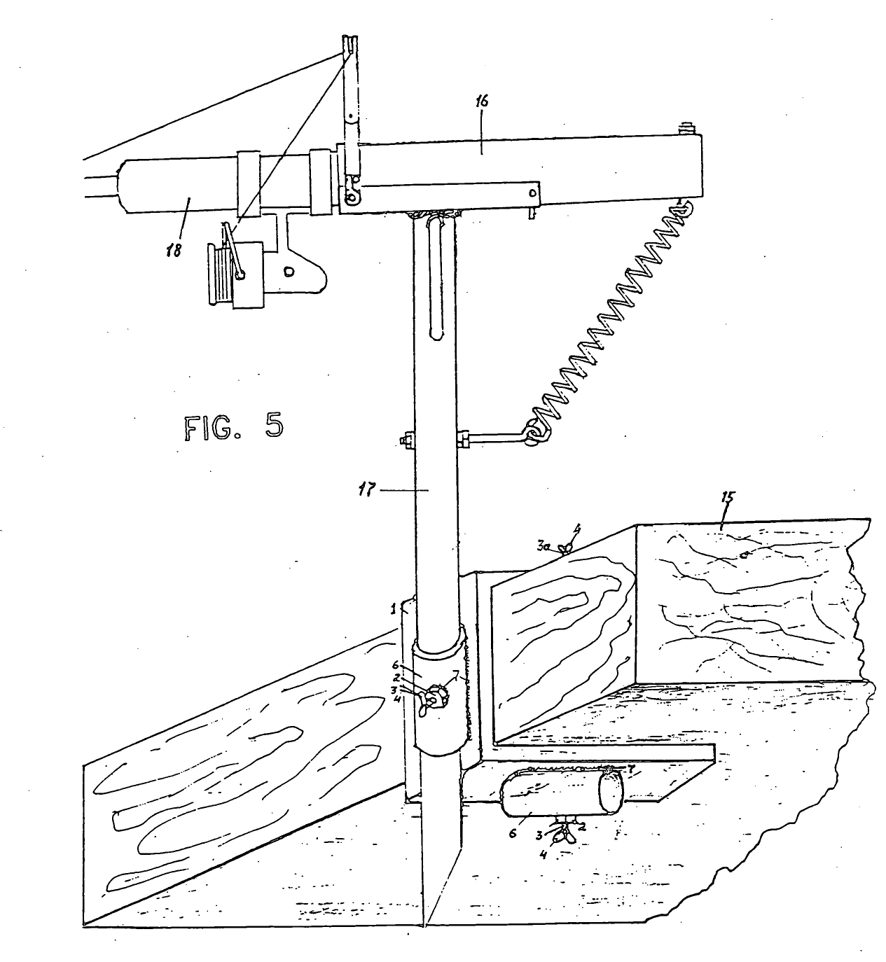

FIGS. 4 and 5 illustrate the universal clamp 10 of the invention in use. Referring to FIG. 4, the universal clamp 10 is shown in a top-mounted orientation, i.e., being mounted to the top side of a surface such as a hand-rail of a pier. To mount the universal clamp 10 on the hand-rail 15, first the bolt 3a is unscrewed to move the clamping disk 5a away from sidewall 13. When the space between clamping disk 5 and sidewall 13 is wide enough to accommodate the width of the top part of the hand-rail 15, the universal clamp 10 of the invention is simply placed on the hand-rail 15 and is slid down until sidewall 12 comes into contact with the hand-rail 15. At this point, the screw 3a is screwed in as far in as possible to engage the clamping disk 5 with the hand-rail 15. Once the clamping disk 5 is in tight contact with the surface of the hand-rail 15, the universal clamp 10 is ready to accommodate a fishing rod holder 18.

The fishing rod holder 16 has a metal stake 17 which is simply inserted into and through the opening of the pipe 6 of the universal clamp 10. Once the end of the metal stake 17 is inserted all the way through the opening of the pipe 6, the bolt 3 is screwed in until it comes into contact with the metal stake 17. This firmly secures the metal stake 17 inside of the pipe 6 and insures that the fishing rod holder 16 is stable. Once the fishing rod holder is stably engaged with the universal clamp 10, the fisherman can insert a fishing rod 18 into the fishing rod holder and begin fishing.

FIG. 5 shows the universal clamp 10 of the invention as attached to a side part of a hard surface, instead of a top part, as is illustrated in FIG. 4. This ability of the universal clamp 10 to attach to any side of a surface allows the fisherman greater leeway in choosing a fishing location. As shown in its top-mounted configuration of FIG. 4, the universal clamp 10 can be attached to hand-rails of piers, bridges, etc. As shown in its side-mounted configuration of FIG. 5, the universal clamp 10 can be mounted on seats or benches of motor boats or benches on piers.

Many modifications and variations are possible in light of the above teaching. The foregoing is a description of the preferred embodiments of the invention and has been presented for the purpose of illustration and description. It is not intended to be exhaustive and so limit the invention to the precise form disclosed.

The invention is to be determined by the following claims:

I claim:

1. A universal clamp for mounting fishing rod holders on rigid surfaces comprising:
a main body, said body having three sidewalls, one of the sidewalls having a generally centered aperture;
at least one first nut fixedly attached to a sidewall of said main body over said generally centered aperture, said nut having internal grooves designed to accommodate a bolt;
at least one bolt for insertion into said first nut, said bolt having a metallic disk on one end;
at least one pipe attached to at least one other sidewall of said main body, said pipe having a generally centered aperture, the pipe having a hollow cavity for accommodating a stake of a fishing rod holder;
at least one second nut having internal grooves, said nut fixedly attached to said pipe over said aperture in said pipe;
at least one bolt for insertion into said nut, said bolt having grooves to match the grooves on said nut;
wherein said clamp can be securely attached to rigid surfaces allowing a fisherman to mount a fishing rod holder into said hollow cavity of said pipe.

2. The universal clamp of claim 1, said clamp comprising two said pipes, each said pipe being attached to a sidewall of said main body.

3. The universal clamp of claim 1 wherein each said bolt comprises a winged-nut on one end.

4. The universal clamp of claim 1 wherein said metallic disk is curved.
